(19) United States
(12) Patent Application Publication
(10) Pub. No.: US 2001/0050973 A1
(43) Pub. Date: Dec. 13, 2001

(54) Radiation image obtaining apparatus

(75) Inventor: Eiji Ogawa, Kaisei-machi (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: FUJI PHOTO FILM CO., LTD.

(21) Appl. No.: 09/878,202

(22) Filed: Jun. 12, 2001

(30) Foreign Application Priority Data
Jun. 12, 2000 (JP) 175272/2000

(51) Int. Cl. G21K 1/00

(52) U.S. Cl. 378/154

(57) ABSTRACT

A radiation image obtaining apparatus having an anti-scatter grid effectively eliminates an effect of scattered beams even in cases where the radiation image is taken using a radiation beam generated with a relatively high peak voltage. A source of the radiation beam generates the radiation beam with a peak voltage as high as 50-150 kvp, which generally induces the scattered beams of high intensities. The anti-scatter grid is an air-grid or a foamed material grid exhibiting direct beam transmittance of 70% or more for the generated radiation beam. An image signal representing a radiation image of a high S/N ratio containing only little noise due to the scattered beams can be obtained even with such a high peak voltage, as the transmittance of the radiation beam can be maintained at a high level while the effect of the scattered beam is eliminated.

### BACKGROUND OF THE INVENTION

1. Field of the Invention

The present invention relates to a radiation image obtaining apparatus for obtaining an image signal representing a radiation image of an object, and more specifically, to a radiation image obtaining apparatus for obtaining an image signal representing a radiation image of an object taken using an anti-scatter grid.

2. Description of the Related Art

Heretofore, there have been widely used radiation image recording and reproducing systems utilizing stimulable phosphors as disclosed in, for example, Japanese Unexamined Patent Publications Nos. 55(1980)-12429, 56(1981)-11395, 55(1980)-163472, 56(1981)-164645 and 55(1980)-116340. In those systems, a radiation image of an object (e.g., a human body) is recorded on a stimulable phosphor sheet, which is capable of recording a portion of radiation energy of a radiation beam (e.g., X-ray, α-ray, β-ray, γ-ray, electron beam or ultraviolet beam) irradiated thereon. A beam of stimulating light (e.g., a laser beam or a beam of visible light) is variably deflected to scan individual pixels of the radiation image recorded on the stimulable phosphor sheet. The beam of stimulating light causes each pixel to emit stimulated emission with an intensity proportional to the amount of radiation energy stored thereon. The stimulated emission emitted successively from the individual pixels of the radiation image recorded on the stimulable phosphor sheet is photoelectrically detected and converted into an electric image signal by photoelectric reading means. The radiation image of the object is then reproduced on a recording material such as a photographic material, a CRT display, etc., as a visible image based on the obtained image signal.

There have also been so-called built-in type radiation image recording and reading apparatuses as disclosed in, for example, Japanese Unexamined Patent Publications Nos. 58(1983)-200269, 59(1984)-192240 and 3(1991)-238441, all of which were filed by the same applicant as the present invention. Each of the built-in type radiation image recording and reading apparatuses comprises circulation means for transferring a stimulable phosphor sheet along a circulation path, an image recording portion provided on the circulation path for recording a radiation image of an object onto the stimulable phosphor sheet, an image reading portion provided on the circulation path for reading the recorded radiation image, and an erasing portion provided on the circulation path for releasing the radiation energy remaining on the stimulable phosphor sheet after the reading process of the radiation image. Such built-in type apparatuses realize reduced operation costs by enabling reuse of the stimulable phosphor sheet.

In addition to radiation image obtaining apparatuses which record the radiation image onto the stimulable phosphor sheet, various types of radiation image obtaining apparatuses have been proposed. Some of such apparatuses use a selenium plate to obtain the radiation image, while others use a scintillator or a photoeletric conversion element.

Use of an anti-scatter grid is a widely-known technique for obtaining a transmission image of high quality containing only a small portion of a scattered beam. The term “transmission image” refers to a radiation image representing distribution of portions of the radiation beam transmitted through the object. The anti-scatter grid is capable of absorbing the scattered beams, i.e., portions of the radiation beam which are scattered while traveling through the object.

The anti-scatter grid generally has a plate-like shape including strip-like radiation absorbing portions and radiation transmitting portions arranged alternately. The length direction of each of the strip-like radiation absorbing portions and the radiation transmitting portions is perpendicular to the travelling direction of the radiation beam. The strip-like radiation absorbing portions and the radiation transmitting portions may be arranged in parallel, or may be arranged with different inclinations so that inclination directions thereof converge on a position of a source of the radiation beam. A supporting member is used to keep the entire radiation absorbing portions and radiation transmitting portions in the plate-like shape. The scattered beams, i.e., the portions of the radiation beam which are scattered by the object and travel in deflected directions, are absorbed and removed by the radiation absorbing portions. Thus, a detector only detects main transmitted beams transmitted through the radiation transmitting portions, i.e., portions of the radiation beam which travel substantially straightly through the radiation transmitting portions of the object. The detected main transmitted beams form the transmission image. The radiation transmitting portions are made of wood, aluminum, etc. On the other hand, the radiation absorbing portions are made of lead etc., which is more rigid than the above materials for the radiation transmitting portions. The strength of the entire anti-scatter grid is reinforced by arranging such a rigid radiation transmitting portion between each adjacent radiation transmitting portions.

It is desirable to make the transmittance through the radiation transmitting portions as high as possible with respect to the adopted radiation beam, as lower transmittance results in a lower S/N ratio and thus in lower image quality. For that reason, various types of the anti-scatter grid have been proposed (see, e.g., Japanese Unexamined Patent Publication No. 10(1998)-5207), including a so-called air-grid using blank spaces as the radiation transmitting portions and a foamed material grid using a foamed material as the material for the radiation transmitting portions.

In each of the above radiation image obtaining apparatuses (and the above radiation image recording and reading apparatuses), a greater peak voltage of the source of the radiation beam results in stronger scattered beams. For that reason, there has been a demand for effective elimination of the effect of the scattered beams especially for cases where the radiation image is taken using a radiation beam generated with a relatively high peak voltage.

### SUMMARY OF THE INVENTION

An object of the present invention is to provide a radiation image obtaining apparatus capable of effectively removing scattered beams.

A radiation image obtaining apparatus according to the present invention comprises: a source of a radiation beam for irradiating an object with the radiation beam; and an anti-scatter grid including a plurality of strips made of a material capable of absorbing the radiation beam; wherein the strips are arranged with predetermined intervals and with length directions aligned perpendicular to a travelling direction of the radiation beam, over an entire area receiving portions of the radiation beam transmitted through the object; wherein an image signal representing a radiation image of the object is obtained based on intensities of the portions of the radiation beam transmitted through the object; and wherein direct beam transmittance through the anti-scatter grid is 70% or more for cases where peak voltage of the source of the radiation beam is within the range of 50-150 kvp.

The above radiation image obtaining apparatus may be either of an apparatus which records the radiation image onto a stimulable phosphor sheet so that the image signal representing the radiation image is obtained by reading the radiation image recorded thereon, an apparatus using a selenium plate for recording the radiation image, or an apparatus using a scintillator or a photoeletric conversion element for recording the radiation image.

It is desirable to adopt an air-grid or a foamed material grid as the anti-scatter grid used in the above radiation image obtaining apparatus according to the present invention.

In addition, it is desirable that the above radiation image obtaining apparatus according to the present invention further comprises processing means for removing patterns generated by the anti-scatter grid from the image signal.

By using the above radiation image obtaining apparatus according to the present invention in which the direct beam transmittance through the anti-scatter grid is 70% or more for cases where the peak voltage of the source of the radiation beam is as high as 50-150 kvp, it becomes possible to eliminate the effect of the scattered beams while maintaining the transmittance of the radiation beam at a high level even when the peak voltage of the source of the radiation beam is relatively high. Accordingly, it becomes possible to obtain an image signal representing a radiation image of a high S/N ratio containing only a little noise due to the scattered beams.

In addition, in the case where the above radiation image obtaining apparatus further comprises the processing means for removing the frequency component generated by the anti-scatter grid from the image signal, it is possible to restrain a stripe pattern corresponding to the pattern of the grid included in the radiation image represented by the obtained image signal.

### BRIEF DESCRIPTION OF THE DRAWINGS

FIG. 1 is a perspective view showing a possible structure of a radiation image recording and reading apparatus according to one embodiment of the present invention,

FIG. 2 shows the internal structure of the radiation image recording and reading apparatus shown in FIG. 1,

FIG. 3 is a schematic view showing a possible structure of an anti-scatter grid, and

FIG. 4 is a block diagram showing a process of removing a grid pattern.

### DESCRIPTION OF THE PREFERRED EMBODIMENTS

Now, specific embodiments of the present invention will be described with reference to the accompanying drawings.

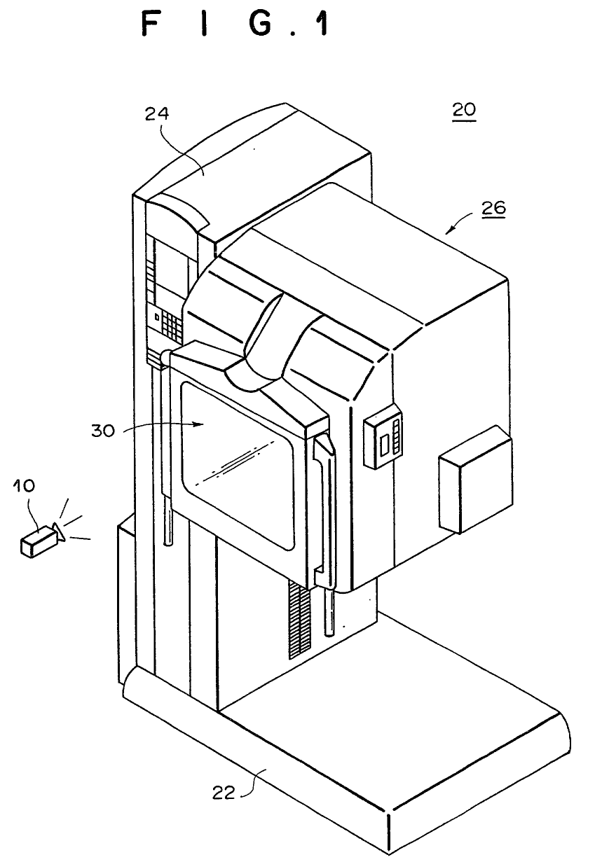

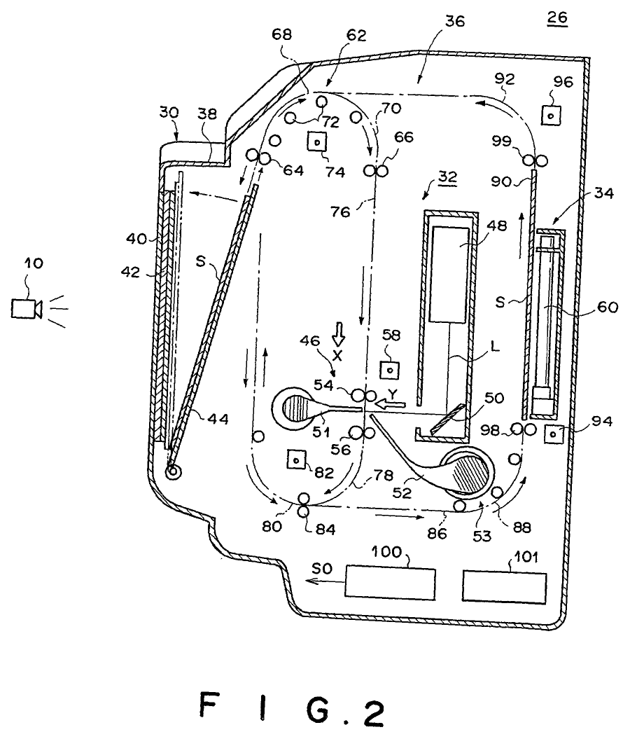

FIG. 1 is a perspective view showing a possible structure of a radiation image recording and reading apparatus according to one embodiment of the present invention, and FIG. 2 shows the internal structure of the radiation image recording and reading apparatus shown in FIG. 1.

A radiation image recording and reading apparatus 20 includes an elevator portion 24 extending upward from a base platform 22. The elevator portion 24 holds a main body 26 of the apparatus 20 using an actuator mechanism such as a ball screw or a cylinder (not shown) to enable vertical movement of the main body 26. The apparatus 20 circulates two stimulable phosphor sheets S within the main body 26 to enable repeated processes of recording and reading radiation images of an object.

As shown in FIG. 2, the main body 26 of the apparatus 20 contains: an image recording portion 30 for recording the radiation image of the object onto one of the stimulable phosphor sheets S; an image reading portion 32 for photoelectrically reading the recorded radiation image by irradiating the stimulable phosphor sheet S carrying the radiation image with a laser beam L acting as a beam of stimulating light; an erasing portion 34 for releasing the radiation energy remaining on the stimulable phosphor sheet S after the process of reading the radiation image; and a circulation system 36 for transferring each of the stimulable phosphor sheets S along a predetermined circulation path connecting the image recording portion 30, the image reading portion 32 and the erasing portion 34. Each of the stimulable phosphor sheets S adopts a transparent substrate, so that stimulated emission occurs not only on a recording surface of the stimulable phosphor sheet S but also on the rear surface (or an emulsion surface) when the recording surface is irradiated with the laser beam L.

The image recording portion 30 includes a covering 38 fixed on the front side of the main body of the apparatus 20. On the inner surface of the casing 38, an automatic exposure control 40 and an anti-scatter grid 42 (hereinafter, referred to simply as “the grid 42”) are superposed in this order. A presser plate 44 is provided on the inner side of the grid 42 for holding one of the stimulable phosphor sheets S at an image-recording position thereof. The radiation beam generated by a source 10 and transmitted through the object projects onto the stimulable phosphor sheet S held at the image-recording position thereof in the image recording portion 30, so that the radiation image of the object is recorded on the stimulable phosphor sheet S. The source 10 of the radiation beam is a source that emits the radiation beam with a peak voltage within the range of 50-150 kvp.

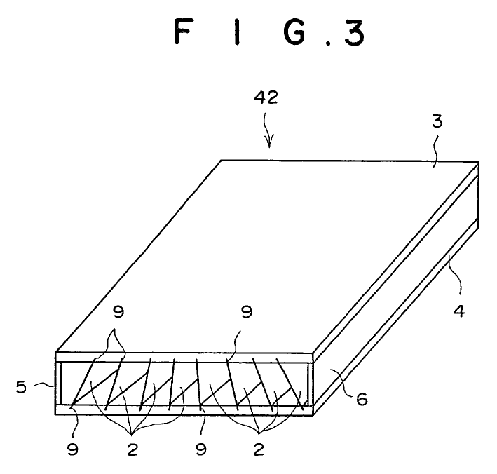

FIG. 3 is a perspective view showing a possible structure of the grid 42. Note that FIG. 3 is a schematic drawing for illustrative purposes, in which thickness of each member, the number of strips, relative dimensions of individual members, etc., are not quite exact.

The grid 42 is an air-grid including a plurality of strips 2 each made of a material capable of absorbing the radiation beam, e.g., lead, tantalum or tungsten. The strips 2 are arranged with different inclinations so that the inclination directions thereof converge on the position of the source 10 of the radiation beam. The grid 42 also includes a top plate 3 and a bottom plate 4 for fixing the strips 2 in place. Relative positions of the top plate 3 and the bottom plate 4 are fixed by fixation plates 5 and 6 provided on opposite sides thereof. A plurality of slots 9 are cut on the top plate 3 and the bottom plate 4 with different inclinations corresponding to the above inclinations for the strips 2, so that the grid 42 is appropriately formed by inserting the strips 2 into the individual slots 9. As the position of the source 10 of the radiation beam substantially corresponds to the position of the center of the grid 42, the outermost two of the strips 2 are inclined with the largest inclination toward the source 10, while the other strips 2 located closer to the center of the grid 42 have gradually-decreased inclinations. Only one of the strips 2 which is located at the center of the grid 42 is perpendicular to the planes of the top plate 3 and the bottom plate 4. It is desirable to use a material containing either of lead, tantalum or tungsten by a weight ratio of 50% or more as the material for the strips 2.

Direct beam transmittance through the grid 42 having the above-described structure is 70% or more. Especially, the transmittance of about 80% can be realized; in the case where a tantalum plate having the thickness of 100 μm is used as the material for the strips 2, the height of each strip 2 is 10 mm, the interval between each adjacent strips 2 on the top plate 3 is 1 mm, the number of the strips per centimeter is ten, two carbon plates are used as the top plate 3 and the bottom plate 4, and the individual strips 2 are appropriately inclined assuming the source 10 of the radiation beam separated from the grid 42 by 180 cm. On the other hand, the transmittance is less than 60% for a grid including alternately-arranged strips made of lead and radiation transmitting portions made of aluminum (the number of strips per centimeter=40), when measured according to the JIS Z4910 standard.

Within the radiation image recording and reading apparatus 20, the grid 42 is periodically driven in up and down directions in FIG. 2 by a grid driving apparatus (not shown).

The image reading portion 32 arranged substantially parallel to the image recording portion 30 includes: transferring means 46 for transferring each stimulable phosphor sheet S in the downward direction in FIG. 2 (i.e., the direction indicated by an arrow X); and a stimulating light source 48 for generating a laser beam L as the stimulating light, wherein the laser beam L is subsequently led in a substantially horizontal direction in FIG. 2 onto the stimulable phosphor sheet S being transferred by the transferring means 46 so that the stimulable phosphor sheet S is scanned by the laser beam L.

The stimulating light source 48 emits the laser beam L in the downward direction. The emitted laser beam L is reflected in the substantially horizontal direction (i.e., the direction indicated by an arrow Y) by an optical component 50, and irradiates the stimulable phosphor sheet S. A first light-collecting guide 51 and a second light-collecting guide 52 are provided near an irradiation spot on the stimulable phosphor sheet S for collecting the stimulated emission induced on both sides of the stimulable phosphor sheet S upon irradiation thereof with the laser beam L. These first and second light-collecting guide 51 and 52 and a photomultiplier (not shown) connected thereto constitutes light-collecting means 53. The photomultiplier photoelectrically converts the stimulated emission collected by the first and second light-collecting guide 51 and 52 into electric signals. The electric signals are added and processed in a predetermined manner in image processing means 100 into an image signal S0 representing the radiation image recorded on the stimulable phosphor sheet S.

The transferring means 46 includes a first roller pair 54 and a second roller pair 56, separated from each other by a predetermined separation in the vertical direction in FIG. 2. The first and second roller pairs 54 and 56 are rotationally driven with a predetermined period by force transferring mean (not shown), such as a conveyer belt or pulleys, connected to a motor 58.

The erasing portion 34 arranged substantially parallel to the image recording portion 30 and the image reading portion 32 includes a plurality of erasing light sources 60 aligned in the vertical direction in FIG. 2. In another embodiment, the erasing light sources 60 may instead be aligned in the horizontal direction.

The circulation system 36 located between the image recording portion 30 and the image reading portion 32 includes reversing and transferring means 62, which transfers the stimulable phosphor sheet S from the image recording portion 30 to the image reading portion 32 while reversing the stimulable phosphor sheet S. The reversing and transferring means 62 includes: a roller pair 64 located near a sheet feeding position of the image recording portion 30; a roller pair 66 located at a position higher than the image reading portion 32; curved guiding plates 68 and 70 arranged along a portion of the circulation path between the roller pairs 64 and 66; and a plurality of guiding rollers 72 arranged along the lower faces of the curved guiding plates 68 and 70. Each of the curved guiding plates 68 and 70 includes narrow-width portions, which are suitable for supporting the stimulable phosphor sheet S only at side-edge portions thereof while guiding the stimulable phosphor sheet S. The roller pairs 64 and 66 are rotationally driven by a motor 74.

Another pair of guiding plates 76 is provided below the roller pair 66 for guiding the stimulable phosphor sheet S downward to the image reading portion 32 while supporting the stimulable phosphor sheet S only at the side-edge portions thereof. In addition, curved guiding plates 78 and 80 are arranged along an end portion of the circulation path for guiding the scanned stimulable phosphor sheet S along the curved end portion of the circulation path while supporting the stimulable phosphor sheet S only at the side-edge portions thereof. An end portion of the curved guiding plate 80 extends straightly in an upward direction.

Provided between the curved guiding plates 78 and 80 is a roller pair 84 rotationally driven by a motor 82. Another guiding plate 86 is extended horizontally from a position adjacent to the roller pair 84 toward the second light-collecting guide 52. The guiding plate 86 connects to a curved guiding plate 88, and then to a straight guiding plate 90 extending vertically along the erasing portion 34. The guiding plate 90 further connects to another curved guiding plate 92. The end of the curved guiding plate 92 is disposed adjacent to the end of the curved guiding plate 68. Roller pairs 98 and 99 rotationally driven by motors 94 and 96 are provided below and above the guiding plate 90, respectively.

The overall operation of the above radiation image recording and reading apparatus 20 according to the present embodiment is controlled by controlling means 101.

Next, the operation of the above radiation image recording and reading apparatus 20 will be described in detail.

The main body 26 of the apparatus 20 contains two stimulable phosphor sheets S. When one of the stimulable phosphor sheets S is located in the image recording portion 30, the other is in the stand-by state in the erasing portion 34 (see FIG. 2). In the image recording portion 30, the presser plate 44 presses one of the stimulable phosphor sheets S onto the grid 42, so that the stimulable phosphor sheet S faces the object (not shown) via the grid 42 and the automatic exposure control 40. Then, the source 10 of the radiation beam is operated with a peak voltage within the range of 50-150 kvp so that the radiation image of the object is recorded onto the stimulable phosphor sheet S. During the process of recording the radiation image onto the stimulable phosphor sheet S, the grid 42 is periodically moved in up and down directions in FIG. 2 so that an undesirable effect of a grid pattern of the grid 42 is suppressed in the radiation image recorded on the stimulable phosphor sheet S.

The stimulable phosphor sheet S after the recording process is moved inward together with the presser plate 44 so that the stimulable phosphor sheet S is fed to the roller pair 64. The controlling means 101 recognizes that the recording process has finished by detecting the inward movement of the presser plate 44. The roller pair 64 is rotationally driven by the motor 74 to transfer the stimulable phosphor sheet to the reversing and transferring means 62. Within the reversing and transferring means 62, the curved guiding plates 68 and 70 and a plurality of guiding rollers 72 reverse the stimulable phosphor sheet S, while keeping the recording surface of the stimulable phosphor sheet S untouched by any member. The reversed stimulable phosphor sheet S is fed to the roller pair 66, and then onto the guiding plate 76 extending vertically. The guiding plate 76 guides the stimulable phosphor sheet S to the transferring means 46 constituting the image reading portion 32, while supporting the side-edge portions of the stimulable phosphor sheet.

The motor 58 drives the first and second roller pairs 54 and 56 constituting the transferring means 46, so that the stimulable phosphor sheet S is transferred by the first and second roller pairs 54 and 56 in the downward direction (i.e., the direction indicated by an arrow X) while being scanned with the laser beam L.

Herein, the controlling means 101 has been programmed with a certain stand-by time, i.e., the time interval between the end of the recording process and the beginning of the reading process, derived from the peak voltage of the source 10 upon recording and from information on recording time according to the automatic exposure control 40. Once the presser plate 44 is moved inward, the controlling means 101 begins to count the stand-by time. The operation of the motor 58 is suspended during the stand-by time, so that the stimulable phosphor sheet S is held in a stand-by state at a position higher than the image reading portion 32 until the stand-by time is counted over. After counting over the entire stand-by time, the controlling means 101 starts the operation of the motor 58 to rotate the first roller pair 54 so that the stimulable phosphor sheet S is fed to the image reading portion 32.

Once the process of feeding the stimulable phosphor sheet S to the image reading portion 32 is started, the stimulating light source 48 starts emission of the laser beam L. The laser beam L first travels in the downward direction, and is then reflected by the optical component 50 in the substantially horizontal direction (i.e., the direction indicated by an arrow Y) toward the recording surface of the stimulable phosphor sheet S so that the recording surface is scanned with the laser beam L. The stimulable phosphor sheet S irradiated with the laser beam L emits stimulated emission on both surfaces thereof, i.e., on both the recording surface and the rear surface (or the emulsion surface). The stimulated emission is collected by the light-collecting guides 51 and 52, and then converted into electric signals by the photomultiplier (not shown). The electric signals are added and processed in a predetermined manner in the image processing means 100 into the image signal S0.

During the reading process by the image reading portion 32, the leading edge of the stimulable phosphor sheet S is guided along the curved guiding plates 78 and 80, and gradually transferred upward along the circulation path by the roller pair 84. When the entire reading process is completed, the rear edge of the stimulable phosphor sheet S is disposed at a position near the roller pair 84. At this point, the motor 82 begins to rotate the roller pair 84 in the reverse directions.

Because of the reverse rotation of the roller pair 84, the stimulable phosphor sheet S is now transferred in the horizontal direction along the guiding plate 86, with the recording surface thereof facing downward. Thereafter, the curved guiding plate 88 changes the transferring direction of the stimulable phosphor sheet S to the upward direction. At this point, the motor 94 begins to rotate the roller pair 98 so that the stimulable phosphor sheet S is transferred in the upward direction along the straight guiding plate 90. At the same time, the erasing light sources 60 constituting the erasing portion 34 are switched on to release the radiation energy remaining on the stimulable phosphor sheet S. The stimulable phosphor sheet S after the erasing process will be held in the stand-by state within the erasing portion 34.

On the other hand, the other stimulable phosphor sheet S, which was held in the stand-by state in the erasing portion 34 at the beginning of the above-described operation, is transferred by the roller pair 99 driven by the motor 96 along the curved guiding plate 92 to the curved guiding plate 68. Then, the roller pair 64 rotated in the inverse directions feeds this stimulable phosphor sheet S to the image recording portion 30. The presser plate 44 now holds this stimulable phosphor sheet S at the image-recording position thereof during the process of recording another radiation image of the object (not shown) In the above radiation image recording and reading apparatus 20 according to the present embodiment, the direct beam transmittance through the grid 42 is 70% or more for cases where the peak voltage of the source 10 of the radiation beam is as high as 50-150 kvp. Thus, it is now possible to eliminate the effect of the scattered beams while maintaining the transmittance of the radiation beam at a high level even when the peak voltage of the source 10 of the radiation beam is relatively high. Accordingly, it is possible to obtain the image signal representing a radiation image of a high S/N ratio containing only a little noise due to the scattered beams.

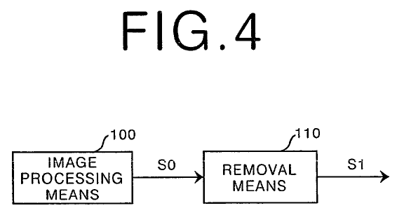

In the above embodiment, the grid pattern (i.e., a stripe pattern corresponding to the pattern of the grid 42) is not completely removed from the radiation image represented by the image signal S0, though it is substantially suppressed by the up-and-down movement of the grid 42 during the recording process. Thus, as shown in FIG. 4, it is more desirable to provide processing means 110 for removing a signal component corresponding to the grid pattern from the image signal S0 generated by the image processing means 100, so that a processed image signal S1 with a further-restrained grid pattern is thereby derived from the image signal S0.

The processing means 110 may derive the image signal S1 with the further-restrained grid pattern by applying Fourier transform to the image signal S0, removing the frequency component corresponding to the grid pattern from the transformed signal, and applying inverse Fourier transform thereto (see, for example, Japanese Unexamined Patent Publication No. 3(1992)-12785). Otherwise, the processing means 110 may derive the image signal S1 by applying a filtering process for removing the spatial frequency component corresponding to the grid pattern from the image signal S0 (see, for example, Japanese Unexamined Patent Publication No. 3(1992)-114039). Herein, a filter used in the filtering process for restraining the grid pattern may reduce response ratio of the spatial frequency component corresponding to the pitch of the grid 42, which is originally 97%, preferably to 5% and more preferably to 2% (see Japanese Unexamined Patent Publication No. 2000-3440).

Another technique for removing the grid pattern from the image signal S0 makes use of two-dimensional wavelet transform (see Japanese Unexamined Patent Publication No. 2000-11174). In this technique, the image signal S0 is transformed into two signals based on the two-dimensional wavelet transform using a low-pass filter. The low-pass filter is one capable of reducing the response ratio for the spatial frequency equal to or greater than the spatial frequency corresponding to the pitch of the grid 42 substantially to zero, to thereby divide the frequency band of the image signal S0 in two. One of the divided signals which contains the spatial frequency component corresponding to the pitch of the grid 42 goes through a process of restraining the low-frequency components thereof having frequencies lower than a predetermined value.

Although two light-collecting guides 51 and 52 are used in the above-described embodiment for collecting the stimulated emission induced on both sides of the stimulable phosphor sheet S during the reading process, use of only one of the light-collecting guides (e.g., only the light-collecting guide 52) may be sufficient.

In addition, although an air-grid is used as the grid 42 in the above embodiment, a foamed material grid may be used instead. Also, it is possible to use another material for the radiation transmitting portions arranged alternately with the strips 2, as long as the direct beam transmittance through the grid 42 is maintained at 70% or more for cases where the peak voltage of the source of the radiation beam is within the range of 50-150 kvp.

Further, although the radiation image recording and reading apparatus 20 in the above embodiment uses the stimulable phosphor sheet S for recording the radiation image, the radiation image may be recorded in any other manner as long as an image signal representing the radiation image can be obtained. For example, an operation similar to the one described for the above embodiment can be carried out by an apparatus using a selenium plate for recording the radiation image, or by an apparatus using a scintillator or a photoeletric conversion element for recording the radiation image.

What is claimed is:

1. A radiation image obtaining apparatus comprising:
a source of a radiation beam for irradiating an object with the radiation beam; and
an anti-scatter grid including a plurality of strips made of a material capable of absorbing the radiation beam; wherein
the strips are arranged with predetermined intervals and with length directions aligned perpendicular to a travelling direction of the radiation beam, over an entire area receiving portions of the radiation beam transmitted through the object; wherein
an image signal representing a radiation image of the object is obtained based on intensities of the portions of the radiation beam transmitted through the object; and wherein
direct beam transmittance through the anti-scatter grid is 70% or more for cases where peak voltage of the source of the radiation beam is within a range of 50-150 kvp.

2. A radiation image obtaining apparatus according to claim 1, further comprising processing means for removing patterns generated by the anti-scatter grid from the image signal.

3. A radiation image obtaining apparatus according to claim 1, wherein the anti-scatter grid is an air-grid or a foamed material grid.

4. A radiation image obtaining apparatus according to claim 3, further comprising processing means for removing patterns generated by the anti-scatter grid from the image signal.
